(19) United States
(12) Patent Application Publication
(10) Pub. No.: US 2009/0268445 A1
(43) Pub. Date: Oct. 29, 2009

(54) Light emitting device

(76) Inventor: Tsung-Hsien Wu, Taipei City (TW)

Correspondence Address: Troxell Law Office Pllc, Suite 1404, 5205 Leesburg Pike, Falls Church, VA, 22041, US

(21) Appl. No.: 12/149,271

(22) Filed: Apr. 29, 2008

(51) Int. Cl. F21V 29/00; F21V 7/00

(52) U.S. Cl. 362/234; 362/235

(57) ABSTRACT

A light emitting device includes a first LED source, a second LED source, a retaining bracket and a reflector. The retaining bracket is provided with a first retaining surface and at least a second retaining surface, the first retaining surface is fixed with the first LED source, the second retaining surface is fixed with the second LED source, the reflector is located corresponding to the second retaining surface and is connected with the retaining bracket. By an installation of a plurality of light sources, luminance of the light emitting device is improved effectively. In addition, by an installation of the reflector, light of the second LED source will be more uniform.

### BACKGROUND OF THE INVENTION

a) Field of the Invention

The present invention relates to a light emitting device, and more particularly to a light emitting device which is provided with higher luminance and a more uniform light source.

b) Description of the Prior Art

As a light emitting diode is provided with advantages of having a high lighting efficiency, a long lifetime of usage, not being damaged easily, consuming less electricity, being environmental benign and having a small volume, it has been one of the most important light sources in recent years. In early years, as the light emitting diode does not have sufficient luminance, it is often used in an indicating lamp or a display panel. However, due to recent breakthrough in material science and technology, the luminance of the light emitting diode has already been improved significantly, especially that as emerging of a white-light light emitting diode, existing conventional illuminating equipment has been gradually replaced by the light emitting diode.

Even more, there are vendors who have developed a kind of seven-colored light emitting diode, an interior of which is provided with a red light spot, a green light spot and a blue light spot, such that when an individual color is needed, the individual light spot is lightened independently; whereas, when all kinds of various colors are needed, two light spots are lightened respectively. For example, a red light and a blue light is equal to a purple light, a red light and a green light is equal to a yellow light, a green light and a blue light is equal to a cyan light, as well as a red light and a greed light and a blue light is equal to a white light. In addition, electric currents of the red, green and blue light spots can be adjusted to form a halftone.

Nevertheless, upon using the aforementioned light emitting diode, following problems and shortcomings actually exist to be improved:
1. Although the light emitting diode is provided with the advantages of high efficiency and long lifetime of usage that it is applied very broadly, its luminance is still insufficient to replace an existing indoor lighting device, such as a fluorescent light.
2. Although the light emitting diode can radiate light of various colors by using different materials, the light emitted is directional due to an illumination principle of the light emitting diode. Therefore, if the light emitting diode is used for a flash light or an illuminating lamp, a better light condensing effect will be available. Yet, when the light emitting diode is used as indoor lighting equipment, a problem of non-uniformity of the light will be resulted as the light emitting diode is directional.

Accordingly, how to solve the aforementioned problems and shortcomings of the prior art, is a technological issue of research and development for improvement by the present inventor and related vendors.

### SUMMARY OF THE INVENTION

The primary object of the present invention is to provide a light emitting device which includes a first LED (light emitting diode) source, a second LED source, a retaining bracket and a reflector, wherein the sources are connected to a power supply end. As the present invention is provided with two light sources, luminance can be significantly improved; therefore, by the aforementioned technology, an issue of insufficient luminance for a conventional light emitting diode can be solved, thereby achieving practicability and advancement with the higher luminance.

Another object of the present invention is provided a light emitting device which includes the first LED source, the second LED source, the retaining bracket and the reflector, wherein the retaining bracket is provided with a first retaining surface and at least a second retaining surface, with the first retaining surface being fixed with the first LED source, the second retaining surface being fixed with the second LED source, and the reflector being located corresponding to the second retaining surface and being connected with the retaining bracket. The second LED source can be an SMD-LED (Surface-Mount Device Light Emitting Diode), an LED or other related electronic illuminating device. When the second LED source is illuminating, as the reflector is provided with a good light reflecting effect by being treated with mirror polishing, the light of second LED source can be radiated uniformly, thereby solving an issue of directionality for the conventional light emitting diode, and achieving the practicability and advancement with the uniform light source.

Still another object of the present invention is to provide a light emitting device, wherein the first LED source and the second LED source can have all kinds of various colors, and can be a seven-colored light emitting diode which is formed with various colors by mixing a red light, a green light and a blue light, so as to provide required color temperatures or colors depending on an existing situation. In addition, if only the luminance is to be increased, then a white light can be formed by just mixing the red light, green light, and blue light. According to the aforementioned technology, the present invention is provided with an advantage of a variety of colors, thereby achieving the practicability and advancement that the conventional light emitting device is in lack of.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a preferred embodiment of the present invention.

FIG. 2 shows a cutaway view of a preferred embodiment of the present invention.

FIG. 3 shows a perspective view of another preferred embodiment of the present invention.

FIG. 4 shows a cutaway view of another preferred embodiment of the present invention.

FIG. 5 shows a schematic view of an operation of a preferred embodiment of the present invention.

FIG. 6 shows a schematic view of an operation of another preferred embodiment of the present invention.

### DETAILED DESCRIPTION OF THE PREFERRED EMBODIMENTS

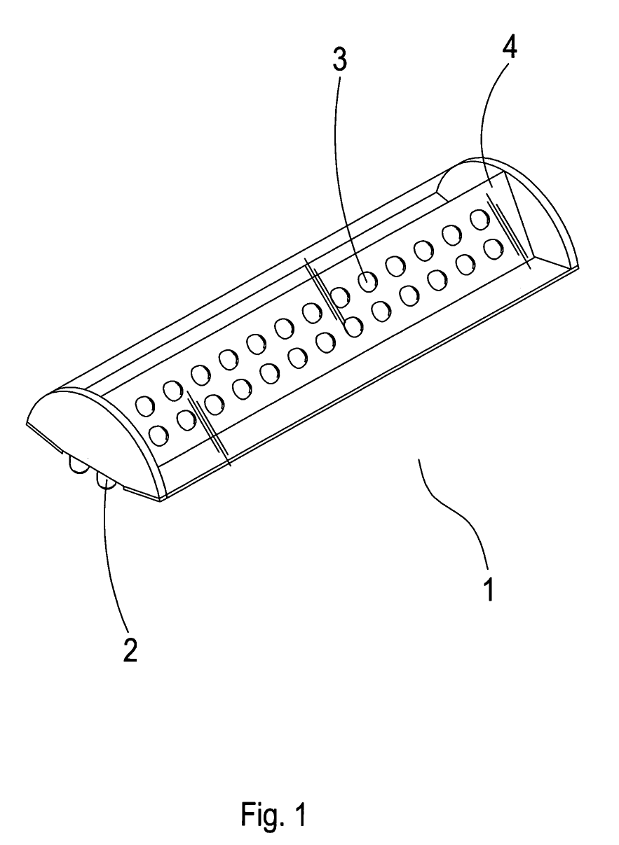

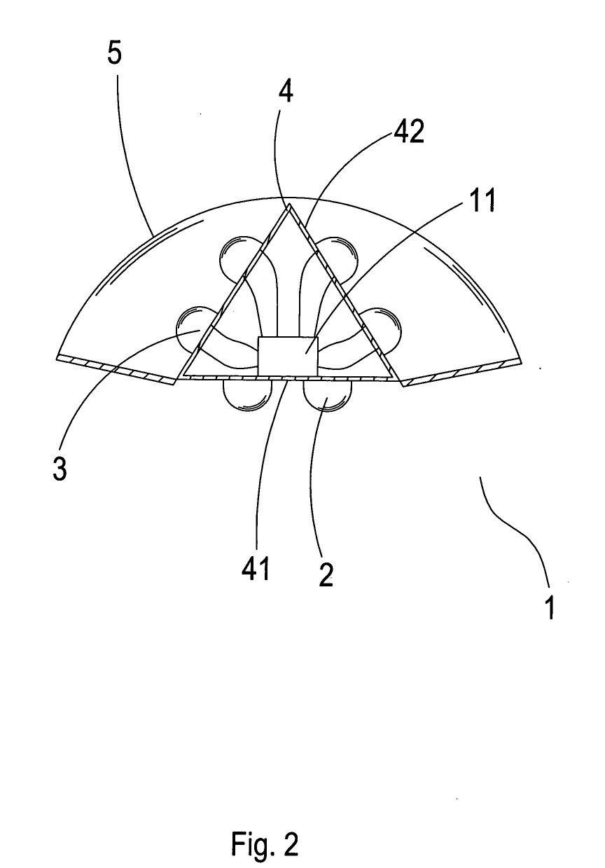

Referring to FIG. 1 and FIG. 2, it shows a perspective view and a cutaway view of a preferred embodiment of the present invention. A light emitting device 1 of the present invention comprises a first LED source 2 and a second LED source 3 which are connected to a power supply end 11, and can be an SMD-LED, an LED or other related electronic illuminating device; a retaining bracket 4 which is provided with a first retaining surface 41 and two second retaining surfaces 42, with the first retaining surface 41 being fixed with the first LED source 2, the second retaining surfaces 42 being fixed with the second LED source 3, and the retaining bracket 4 being made by a material with a good heat dissipation effect; and a reflector 5 which is located corresponding to the second fixing surfaces 42, is connected with the retaining bracket 4 and is provided with a good light reflecting effect by being treated with mirror polishing.

Moreover, the first LED source 2 and the second LED source 3 can have all kinds of various colors and can be a seven-colored light emitting diode.

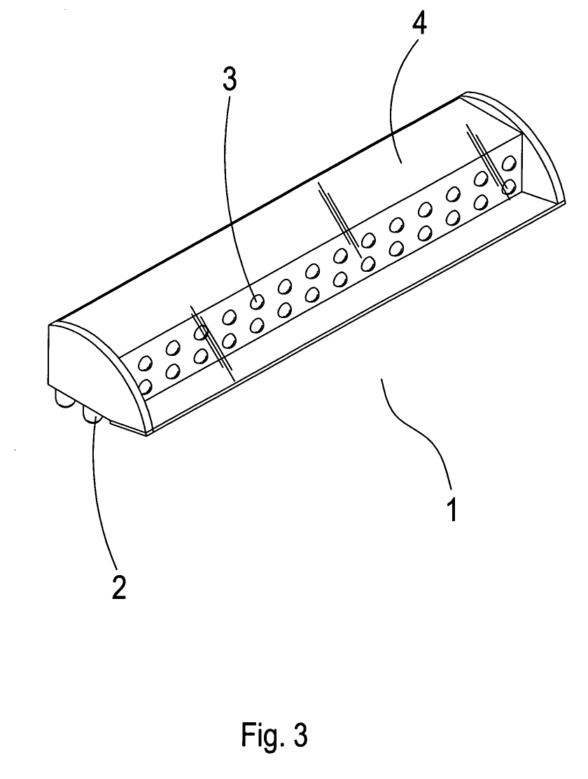

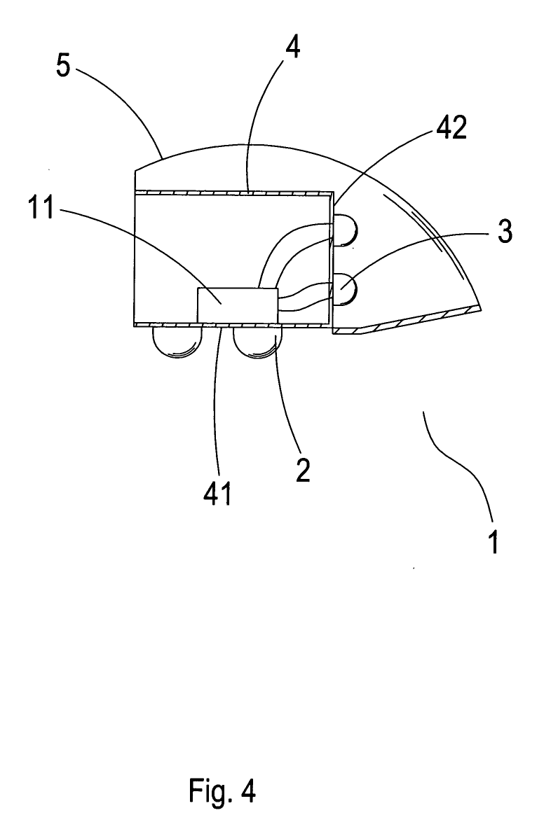

Referring to FIG. 3 and FIG. 4, it shows a perspective view and a cutaway view of another preferred embodiment of the present invention. A light emitting device 1 of the present invention comprises a first LED source 2 and a second LED source 3 which are connected to a power supply end 11 and can be an SMD-LED, an LED or other related electronic illuminating device; a retaining bracket 4 which is provided with a first retaining surface 41 and a second retaining surface 42, with the first retaining surface 41 being fixed with the first LED source 2, the second retaining surface 42 being fixed with the second LED source 3, and the retaining bracket 4 being made by a material with a good heat dissipation effect; and a reflector 5 which is located corresponding to the second retaining surface 42, is connected with the retaining bracket 4 and is provided with a good light reflecting effect by being treated with mirror polishing.

Moreover, the first LED source 2 and the second LED source 3 can have all kinds of various colors and can be a seven-colored light emitting diode.

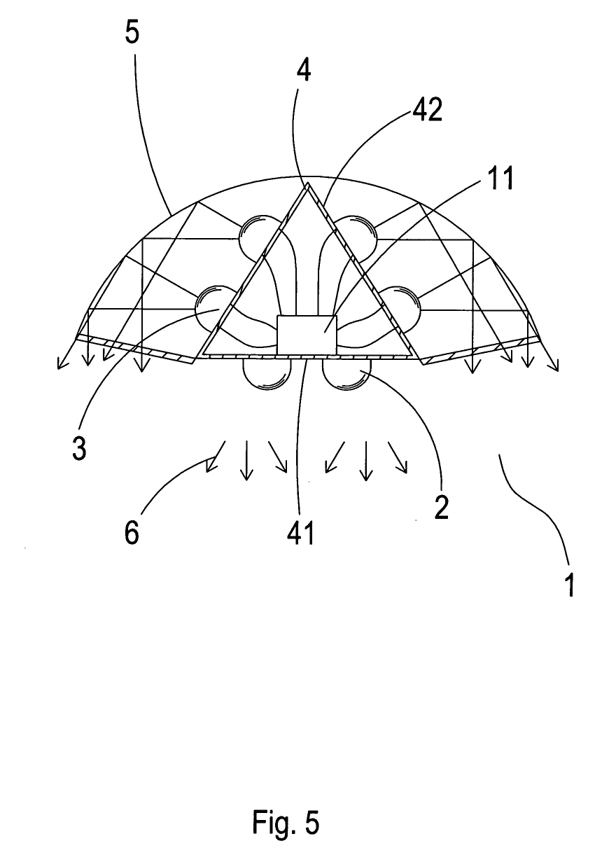

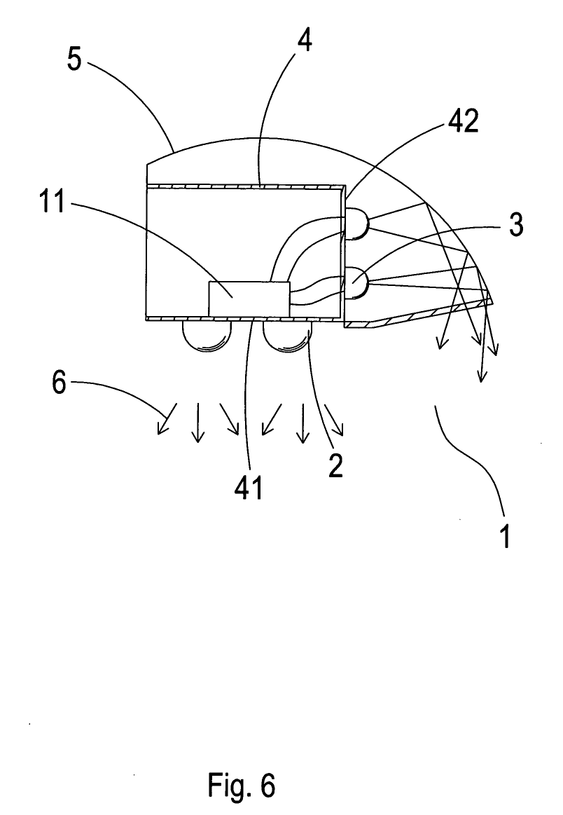

Referring to FIG. 5 and FIG. 6, it shows a schematic view of an operation of a preferred embodiment and a schematic view of an operation of another preferred embodiment of the present invention. Due to that the first LED source 2 is fixed on the first retaining surface 41 of the retaining bracket 4, higher luminance is reached for the light emitting device 1 of the present invention. On the other hand, the second retaining surface 42 of the retaining bracket 4 is fixed with the second LED source 3, and the corresponding surface of the second retaining surface 42 is provided with the reflector 5 having the good light reflecting effect; therefore, when the second LED source 3 is illuminating, light rays 6 can be reflected by the reflector 5, such that the luminance of the light emitting device 1 can be increased effectively and an issue of non-uniformity of light caused by directionality of the light emitting diode can be improved effectively, thereby achieving practicability and advancement that the luminance is increased and light is more uniform.

Furthermore, the first LED source 2 and the second LED source 3 can have all kinds of various colors and can be a seven-colored light emitting diode, so as to adjust into required colors and luminance depending on requirements.

In addition, an issue of heat dissipation to the first LED source 2 and the second LED source 3 is also solved by the present invention. As the retaining bracket 4 is made by a material with a good heat dissipation effect, and the retaining bracket 4 is connected with the reflector 5, heat generated by the first LED source 2 and the second LED source 3 can be transmitted to the reflector 5 through the retaining bracket 4 and is further dissipated by the reflector 5.

Referring to all the drawings, the present invention is actually provided with following advantages in comparison with the prior art:
1. The light emitting device 1 includes the first LED source 2 and the second LED source 3 which can be an SMD-LED, an LED or other related electronic illuminating device. As the light emitting device 1 is provided with two light sources, the luminance can be higher.
2. The light emitting device 1 includes the reflector 5 which is located corresponding to the second retaining surface 42, such that when the second LED source 3 is illuminating, the light rays 6 can be reflected effectively by the reflector 5 to required locations, thereby enabling the luminance of light to be more uniform.
3. The first LED source 2 and the second LED source 3 of the light emitting diode 1 can have all kinds of various colors and can be a seven-colored light emitting diode, so as to adjust into colored light needed depending on requirements in different situations.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A light emitting device comprising a first LED source and a second LED source which are connected to a built-in power supply end; a retaining bracket which is provided with a first retaining surface and at least a second retaining surface, with the first retaining surface being fixed with the first LED source and the second retaining surface being fixed with the second LED source; and a reflector which is located corresponding to the second retaining surface and is connected with the retaining bracket.

2. The light emitting device according to claim 1, wherein the first LED source and the second LED source are an SMD-LED, an LED or other related electronic illuminating device.

3. The light emitting device according to claim 1, wherein the reflector is provided with a good light reflecting effect by being treated with mirror polishing.

4. The light emitting device according to claim 1, wherein the retaining bracket is made by a material with a good heat dissipation effect.

5. The light emitting device according to claim 1, wherein the first LED source and the second LED source have all kinds of various colors.

6. The light emitting device according to claim 5, wherein the first LED source and the second LED source are a seven-colored light emitting diode.
